(19) United States
(12) Patent Application Publication
(10) Pub. No.: US 2024/0290990 A1
(43) Pub. Date: Aug. 29, 2024

(54) Method For Manufacturing Positive Electrode Current Collector Coated With Adhesion Enhancement Layer And Positive Electrode Current Collector Coated With Adhesion Enhancement Layer

(71) Applicant: LG Chem, Ltd., Seoul (KR)

(72) Inventors: Min-Soo Kim, Daejieon (KR); Su-Jin Kim, Daejieon (KR); Jung-Hyun Seo, Daejieon (KR); Soon-Hwa Jung, Daejieon (KR)

(73) Assignee: LG Chem, Ltd., Seoul (KR)

(21) Appl. No.: 18/572,472

(22) PCT Filed: Oct. 24, 2022
(86) PCT No.: PCT/KR2022/016295

§ 371 Date: Dec. 20, 2023

(30) Foreign Application Priority Data
Nov. 3, 2021 (KR) 10-2021-0150118
Nov. 3, 2021 (KR) 10-2021-0150119

(51) Int. Cl. H01M 4/66; H01M 4/02; H01M 4/04; H01M 4/58; H01M 4/62; H01M 10/052

(52) U.S. Cl. CPC H01M 4/667; H01M 4/0404; H01M 4/5825; H01M 4/623; H01M 4/661; H01M 4/668; H01M 10/052; H01M 2004/021; H01M 2004/028

(57) ABSTRACT

A method for manufacturing a positive electrode current collector coated with an adhesion enhancement layer includes preparing an aqueous slurry comprising a first binder polymer comprising polyvinylidene fluoride-based polymer particles having a melting point of 50 to 150° C. and a first conductive material at a weight ratio of 0.5:1 to 8:1; and coating the aqueous slurry on at least one surface of a metal current collector and drying by thermal treatment at higher temperature than the melting point of the polyvinylidene fluoride-based polymer particles to form the adhesion enhancement layer.

### CROSS-REFERENCE TO RELATED APPLICATIONS

The present application is a national phase entry under 35 U.S.C. § 371 of International Application No. PCT/KR2022/016295, filed on Oct. 24, 2022, which claims priority to Korean Patent Application No. 10-2021-0150118 filed on Nov. 3, 2021 and Korean Patent Application No. 10-2021-0150119 filed on Nov. 3, 2021 in the Republic of Korea, the disclosures of which are incorporated herein by reference.

### TECHNICAL FIELD

The present disclosure relates to a method for manufacturing a positive electrode current collector coated with an adhesion enhancement layer, a positive electrode current collector coated with an adhesion enhancement layer manufactured therefrom, a method for manufacturing a positive electrode for a lithium secondary battery, a positive electrode for a lithium secondary battery manufactured therefrom and a lithium secondary battery comprising the same.

### BACKGROUND ART

Recently, with the rapid widespread use of electronic devices using batteries, for example, mobile phones, laptop computers and electric vehicles, there is a fast growing demand for secondary batteries with small size, light weight and relatively high capacity. In particular, lithium secondary batteries are gaining attention as a power source for driving mobile devices due to their light weight and high energy density advantages. Accordingly, there are many research and development efforts to improve the performance of lithium secondary batteries.

A lithium secondary battery comprises a positive electrode and a negative electrode made of active materials capable of intercalating and deintercalating lithium ions and an organic electrolyte solution or a polymer electrolyte solution filled between the positive electrode and the negative electrode, and produces electrical energy by oxidation and reduction reactions during the intercalation/deintercalation of lithium ions at the positive electrode and the negative electrode.

In general, the positive electrode of the lithium secondary battery is manufactured by coating a positive electrode active material slurry comprising a positive electrode active material, a conductive material, a binder polymer and a solvent on a positive electrode current collector made of a metal such as aluminum and drying to form a positive electrode active material layer. Specifically, the positive electrode is manufactured by weighing and mixing each constituent material of the positive electrode active material slurry, coating and drying the positive electrode active material slurry on the positive electrode current collector, and pressing.

The manufactured positive electrode is assembled into the lithium secondary battery through post-processing, and there is a likelihood that the positive electrode active material may be detached due to the low adhesion strength of the positive electrode active material layer and the current collector. This problem gets worse when the positive electrode active material is a lithium iron phosphate based positive electrode active material or the size of the active material is smaller.

To solve this problem, forming an adhesion enhancement layer comprising a binder polymer on the current collector before forming the positive electrode active material layer on the current collector has been proposed, but there is a need for the development of adhesion enhancement layers with high adhesion strength of the positive electrode active material layer to the current collector and low interfacial resistance.

Additionally, there is a need for the manufacture of lithium secondary batteries with reduced energy required to dry the coated adhesion enhancement layer forming slurry and improved adhesion strength with electrodes when applied to lithium secondary batteries comprising electrolyte solutions.

### DISCLOSURE

### Technical Problem

An aspect of the present disclosure is directed to providing a method for manufacturing a positive electrode current collector coated with an adhesion enhancement layer having low interfacial resistance for improving the adhesion strength between a positive electrode active material layer and a current collector, a positive electrode current collector coated with an adhesion enhancement layer manufactured therefrom, a method for manufacturing a positive electrode for a lithium secondary battery, a positive electrode for a lithium secondary battery manufactured therefrom and a lithium secondary battery comprising the same.

Another aspect of the present disclosure is directed to providing a method for manufacturing a positive electrode current collector coated with an adhesion enhancement layer for reducing energy required to dry an aqueous slurry for forming a coated adhesion enhancement layer and maintaining the adhesion strength with electrodes when applied to lithium secondary batteries comprising electrolyte solutions, a positive electrode current collector coated with an adhesion enhancement layer manufactured therefrom, a method for manufacturing a positive electrode for a lithium secondary battery, a positive electrode for a lithium secondary battery manufactured therefrom and a lithium secondary battery comprising the same.

### Technical Solution

In an aspect of the present disclosure, there is provided a method for manufacturing a positive electrode current collector coated with an adhesion enhancement layer according to the following embodiment.

A first embodiment relates to a method for manufacturing a positive electrode current collector coated with an adhesion enhancement layer comprising preparing an aqueous slurry comprising a first binder polymer comprising a polyvinylidenefluoride-based polymer particles having a melting point of 50 to 150° C. and a first conductive material, wherein a weight ratio of the first binder polymer to the first conductive material is 0.5:1 to 8:1; and coating the aqueous slurry on at least one surface of a metal current collector and drying by thermal treatment at a higher temperature than the melting point of the polyvinylidenefluoride-based polymer particles to form the adhesion enhancement layer.

In the first embodiment, a second embodiment relates to the method for manufacturing a positive electrode current collector coated with an adhesion enhancement layer wherein the melting point of the polyvinylidenefluoride-based polymer particles is 70 to 150° C., and more specifically, 90 to 150° C.

In the first or second embodiment, a third embodiment relates to the method for manufacturing a positive electrode current collector coated with an adhesion enhancement layer wherein the polyvinylidenefluoride-based polymer particles are vinylidenefluoride-hexafluoropropylene copolymer particles.

In any one of the first to third embodiments, a fourth embodiment relates to the method for manufacturing a positive electrode current collector coated with an adhesion enhancement layer wherein a weight average molecular weight of the polyvinylidene fluoride-based polymer particles is 700,000 to 1,300,000, and more specifically 800,000 to 1,100,000.

In any one of the first to fourth embodiments, a fifth embodiment relates to the method for manufacturing a positive electrode current collector coated with an adhesion enhancement layer wherein an average particle size of the polyvinylidenefluoride-based polymer particles is 10 nm to 3 μm.

In any one of the first to fifth embodiments, a sixth embodiment relates to the method for manufacturing a positive electrode current collector coated with an adhesion enhancement layer wherein an average particle size of the polyvinylidenefluoride-based polymer particles is 100 nm to 1,000 nm, and an average particle size of the first conductive material is 10 nm to 1,000 nm.

In the sixth embodiment, a seventh embodiment relates to the method for manufacturing a positive electrode current collector coated with an adhesion enhancement layer wherein the average particle size of the polyvinylidenefluoride-based polymer particles is 3 to 20 times larger than the average particle size of the first conductive material.

In any one of the first to seventh embodiments, an eighth embodiment relates to the method for manufacturing a positive electrode current collector coated with an adhesion enhancement layer wherein the higher temperature is higher than the melting point of the polyvinylidenefluoride-based polymer particles by 10 to 80° C.

Another aspect of the present disclosure provides a positive electrode current collector coated with an adhesion enhancement layer according to the following embodiment.

A ninth embodiment relates to a positive electrode current collector coated with an adhesion enhancement layer, comprising a metal current collector; and an adhesion enhancement layer on at least one surface of the metal current collector, the adhesion enhancement layer comprising a first binder polymer and a first conductive material, wherein a weight ratio of the first binder polymer to the first conductive material is 0.5:1 to 8:1, wherein the first binder polymer comprises a polyvinylidenefluoride-based polymer, the first binder polymer is distributed in an island array over the at least one surface of the metal current collector, and a melting point of the polyvinylidenefluoride-based polymer is 50 to 150° C.

In the ninth embodiment, a tenth embodiment relates to the positive electrode current collector coated with an adhesion enhancement layer wherein the melting point of the polyvinylidenefluoride-based polymer is 70 to 150° C., and more specifically 90 to 150° C.

In the ninth or tenth embodiment, an eleventh embodiment relates to the positive electrode current collector coated with an adhesion enhancement layer according to claim 9, wherein the polyvinylidenefluoride-based polymer is a vinylidenefluoride-hexafluoropropylene copolymer.

In any one of the ninth to eleventh embodiments, a twelfth embodiment relates to the positive electrode current collector coated with an adhesion enhancement layer according to claim 9, wherein a weight average molecular weight of the polyvinylidene fluoride-based polymer is 700,000 to 1,300,000, and more specifically 800,000 to 1,100,000.

Another aspect of the present disclosure provides a method for manufacturing a positive electrode for a lithium secondary battery according to the following embodiment.

A thirteenth embodiment relates to a method for manufacturing a positive electrode for a lithium secondary battery comprising manufacturing the positive electrode current collector coated with an adhesion enhancement layer according to any one of the first to eighth embodiments; and stacking a positive electrode active material layer comprising a positive electrode active material, a second conductive material and a second binder polymer on the adhesion enhancement layer and attaching the positive electrode active material layer to the adhesion enhancement layer.

In the thirteenth embodiment, a fourteenth embodiment relates to the method for manufacturing a positive electrode for a lithium secondary battery wherein the metal current collector comprises aluminum, and the positive electrode active material is represented by the following Formula 1:

Li₁₊ₐFe₁₋ₓMₓ(PO_{4-b})X_{b} where M is at least one of Al, Mg, Ni, Co, Mn, Ti, Ga, Cu, V, Nb, Zr, Ce, In, Zn or Y, and X is at least one of F, S or N, −0.5≤a≤+0.5, 0≤x≤0.5, 0≤b≤0.1. <Formula 1>

In the thirteenth or fourteenth embodiment, a fifteenth embodiment relates to the method for manufacturing a positive electrode for a lithium secondary battery wherein the second binder polymer is at least one of polyvinylidenefluoride, poly(vinylidenefluoride-hexafluoropropylene) or poly(vinylidenefluoride-chlorotrifluoroethylene).

In any one of the thirteenth or fifteenth embodiments, a sixteenth embodiment relates to the method for manufacturing a positive electrode for a lithium secondary battery wherein the adhesion enhancement layer is 50 to 5,000 nm in thickness on the at least one surface of the metal current collector, and the positive electrode active material layer is 40 to 200 μm in thickness on at least one surface of the adhesion enhancement layer.

Another aspect of the present disclosure provides a positive electrode for a lithium secondary battery according to the following embodiment.

A seventeenth embodiment relates to a positive electrode for a lithium secondary battery comprising the positive electrode current collector coated with an adhesion enhancement layer according to any one of the ninth to twelfth embodiments; and a positive electrode active material layer attached onto the adhesion enhancement layer, and comprising a positive electrode active material, a second conductive material and a second binder polymer.

In the seventeenth embodiment, an eighteenth embodiment relates to the positive electrode for a lithium secondary battery wherein the metal current collector comprises aluminum, and the positive electrode active material is represented by the following Formula 1:

Li₁₊ₐFe₁₋ₓMₓ(PO_{4-b})X_{b} where M is at least one of Al, Mg, Ni, Co, Mn, Ti, Ga, Cu, V, Nb, Zr, Ce, In, Zn or Y, and X is at least one of F, S or N, −0.5≤a≤+0.5, 0≤x≤0.5, 0≤b≤0.1. <Formula 1>

In the seventeenth or eighteenth embodiment, a nineteenth embodiment relates to the positive electrode for a lithium secondary battery wherein the second binder polymer is at least one of polyvinylidenefluoride, poly(vinylidenefluoride-hexafluoropropylene) or poly(vinylidenefluoride-chlorotrifluoroethylene).

In any one of the seventeenth to nineteenth embodiments, a twentieth embodiment relates to the positive electrode for a lithium secondary battery wherein the adhesion enhancement layer is 50 to 5,000 nm in thickness on the at least one surface of the metal current collector, and the positive electrode active material layer is 40 to 200 μm in thickness on at least one surface of the adhesion enhancement layer.

A twenty first embodiment provides a lithium secondary battery comprising the positive electrode according to any one of the seventeenth to twentieth embodiments, a negative electrode opposite the positive electrode, a separator between the positive electrode and the negative electrode, and an electrolyte.

### Advantageous Effects

According to an embodiment of the present disclosure, the adhesion enhancement layer forming aqueous slurry comprising the polyvinylidenefluoride-based polymer particles having the predetermined melting point range and the first conductive material in the predetermined amount ratio range is coated on the metal current collector and dried at higher temperature than the melting point, and when solidified after melting, the polyvinylidenefluoride-based polymer of the adhesion enhancement layer is distributed in island arrays over the surface of the current collector. That is, the polyvinylidenefluoride-based polymer distributed in island arrays does not cover the entire surface of the current collector. Accordingly, the adhesion enhancement layer improves the adhesion strength between the positive electrode active material layer and the current collector and has low interfacial resistance.

Additionally, with the polyvinylidenefluoride-based polymer having the predetermined melting point range, even when the aqueous slurry is dried at relatively low temperature to reduce energy, the polyvinylidenefluoride-based polymer particles may show good adhesion performance as the adhesion enhancement layer after melting and solidification and have resistance to dissolution in the electrolyte solution when applied to the lithium secondary battery comprising the electrolyte solution, thereby maintaining the adhesion strength with the positive electrode.

### DESCRIPTION OF DRAWINGS

The accompanying drawings illustrate an exemplary embodiment of the present disclosure, and together with the foregoing description of the present disclosure, serve to help a further understanding of the technical aspects of the present disclosure, so the present disclosure should not be construed as being limited to the drawings. Meanwhile, the shape, size, scale or proportion of the elements in the accompanying drawings may be exaggerated to emphasize a more clear description.

FIG. 1 is a scanning electron microscopy (SEM) image of an adhesion enhancement layer according to example 1.

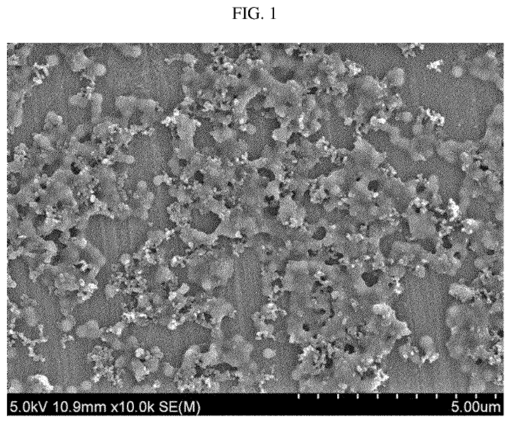

FIG. 2 is a differential scanning calorimetry (DSC) chart of polymer A used in example 1.

### DETAILED DESCRIPTION

Hereinafter, an embodiment of the present disclosure will be described in detail. Prior to the description, it should be understood that the terms or words used in the specification and the appended claims should not be construed as limited to general and dictionary meanings, but interpreted based on the meanings and concepts corresponding to technical aspects of the present disclosure, on the basis of the principle that the inventor is allowed to define terms appropriately for the best explanation. Therefore, the disclosure of the embodiments described herein is an exemplary embodiment of the present disclosure, but not intended to fully describe the technical aspects of the present disclosure, so it should be understood that a variety of other equivalents and modifications could have been made thereto at the time that the application was filed.

According to a method for manufacturing a positive electrode current collector coated with an adhesion enhancement layer according to an aspect of the present disclosure, an aqueous slurry comprising a first binder polymer comprising polyvinylidenefluoride-based polymer particles having the melting point of 50 to 150° C. and a first conductive material at a weight ratio of 0.5:1 to 8:1 is prepared.

The adhesion enhancement layer forming slurry is an aqueous slurry using water as a dispersion medium.

The aqueous slurry may further comprise selectively a solvent, for example, isopropyalcohol, acetone, ethanol and butyl alcohol to reduce the surface energy and improve the coating performance.

The aqueous slurry comprises a first binder polymer to improve the adhesion strength of the metal current collector and the positive electrode active material layer, and for the first binder polymer, the present disclosure comprises, for example, particles of polyvinylidenefluoride-based polymer having the melting point of 50 to 150° C. The use of the particulate polyvinylidenefluoride-based polymer prevents an increase in resistance of the adhesion enhancement layer.

The average particle size of the polyvinylidenefluoride-based polymer particles may be, for example, 10 nm to 3 μm, from the perspective of dispersion and storage safety. In particular, the average particle size of the polyvinylidenefluoride-based polymer particles may be 100 nm to 1,000 nm when considering improvement in bonding to the positive electrode active material layer, phase safety in the slurry and solvent resistance in the electrolyte solution. Additionally, the average particle size of the polyvinylidenefluoride-based polymer particles may be 3 to 20 times larger than the average particle size of the first conductive material.

When the melting point of the polyvinylidenefluoride-based polymer is less than 50° C., there is a high likelihood that the polyvinylidenefluoride-based polymer will dissolve in the electrolyte solution used in the battery assembly and the adhesion strength with the electrode reduces. Additionally, when the melting point exceeds 150° C., the drying temperature of the aqueous slurry as describe below increases so much, resulting in an increase in energy consumption and a decrease in adhesion strength improvement. In this view, more specifically, the melting point of the polyvinylidenefluoride-based polymer may be 70 to 150° C., more specifically 90 to 150° C., and most specifically 100 to 140° C. The polyvinylidenefluoride-based polymer may include, for example, vinylidenefluoride-hexafluoropropylene, but is not limited thereto.

The weight average molecular weight of the polyvinylidene fluoride-based polymer may be 700,000 to 1,300,000, and more specifically 800,000 to 1,100,000. When the weight average molecular weight is in the above-described range, the adhesion strength with the positive electrode active material layer is further enhanced.

In addition to the polyvinylidene fluoride-based polymer particles described above, the aqueous slurry may further comprise another binder polymer in particulate form or dissolved form in water without departing from the objective of the present disclosure.

Meanwhile, the aqueous slurry comprises a first conductive material to prevent an increase in resistance of the positive electrode. The amount of the first conductive material may be, for example, 10 to 200 parts by weight based on 100 parts by weight of the first binder polymer, but is not limited thereto. The average particle size of the first conductive material may be 10 nm to 1,000 nm when considering the dispersion in the slurry and conductivity, but is not limited thereto.

The first conductive material may include, without limitation, any type of conductive material that has conductivity without causing side reaction with the other elements of the battery, for example, graphite such as natural graphite or artificial graphite; carbon black such as carbon black (super-p), acetylene black, ketjen black, channel black, furnace black, lamp black, thermal black; conductive fibers such as carbon fibers or metal fibers; carbon nanotubes such as MW-CNT, SW-CNT; metal powder such as fluorocarbon, aluminum and nickel powder; conductive whiskers such as zinc oxide and potassium titanate; conductive metal oxide such as titanium oxide; or conductive materials such as polyphenylene derivatives, and they may be used singly or in combination to reduce the interfacial resistance.

A weight ratio of the first binder polymer comprising the polyvinylidenefluoride-based polymer particles and the first conductive material in the aqueous slurry is 0.5:1 to 8:1. When the weight ratio is less than 0.5:1, the adhesion strength is poor, and when the weight ratio exceeds 8:1, the interfacial resistance increases so much. In view of this, the weight ratio of the polyvinylidenefluoride-based polymer particles and the first conductive material may be 1:1 to 5:1.

The aqueous slurry may further comprise at least one type of thickening agent to control viscosity. In particular, the thickening agent may include carboxymethylcellulose, hydroxymethylcellulose, ethylcellulose, polyvinylalcohol, casein and methylcellulose, but is not limited thereto.

In addition to the above-described components, the aqueous slurry may further include any other additive, for example, a dispersant without departing from the objective of the present disclosure.

Subsequently, the prepared aqueous slurry is coated on at least one surface of the metal current collector, and dried by thermal treatment at higher temperature than the melting point of the polyvinylidenefluoride-based polymer particles form the adhesion enhancement layer.

For the positive electrode current collector, a metal current collector such as aluminum is used. In particular, aluminum may be used in the form of a foil, and the aluminum foil easily oxidizes in air to form a surface layer of aluminum oxide. Accordingly, the current collector of aluminum should be interpreted as comprising the current collector having the aluminum oxide surface layer formed by the oxidation of aluminum on the surface. The thickness of the metal current collector may be typically 3 to 500 μm, but is not limited thereto.

The common slurry coating methods and devices may be used to coat the aqueous slurry on the metal current collector, and the coating methods may include, for example, a bar coating method such as Meyer bar, a gravure coating method, a 2 roll reverse coating method, a vacuum slot die coating method and a 2 roll coating method. The adhesion enhancement layer is formed on at least one surface of the metal current collector, i.e., one or two surfaces of the metal current collector to improve the adhesion strength between the metal current collector and the positive electrode active material layer as described below. The thickness of the adhesion enhancement layer (the thickness of the adhesion enhancement layer formed on one surface of the metal current collector, not two surfaces) may be, for example, 50 to 5,000 nm, and more specifically 100 to 1,000 nm when considering the adhesion strength improvement effect and the increase in resistance of the positive electrode, but is not limited thereto.

The metal current collector coated with the aqueous slurry is dried by thermal treatment at higher temperature than the melting point of the polyvinylidenefluoride-based polymer particles to form the adhesion enhancement layer. Specifically, the drying process may be performed at higher temperature than the melting point of the polyvinylidenefluoride-based polymer particles by 10 to 80° C., but is not limited thereto.

When the polyvinylidenefluoride-based polymer particles are dried by thermal treatment at higher temperature than the melting point of polyvinylidenefluoride-based polymer particles, the polyvinylidenefluoride-based polymer particles melt, and as the temperature decreases, they are solidified to form the adhesion enhancement layer bonded onto the metal current collector. In this instance, the polyvinylidenefluoride-based polymer of the adhesion enhancement layer is distributed in island arrays over the surface of the current collector. That is, the polyvinylidenefluoride-based polymer distributed in island arrays does not cover the entire surface of the current collector. Accordingly, the adhesion enhancement layer improves the adhesion strength between the positive electrode active material layer and the current collector and has low interfacial resistance.

Additionally, as described above, with the polyvinylidenefluoride-based polymer having the predetermined melting point range, it is possible to dry the aqueous slurry at relatively low temperature to reduce energy consumption, and the adhesion enhancement layer has good adhesion performance. The adhesion enhancement layer is resistant to dissolution in the electrolyte solution when applied to lithium secondary batteries comprising electrolyte solutions, thereby maintaining the adhesion strength with the positive electrode.

The positive electrode current collector coated with the adhesion enhancement layer according to an aspect, manufactured by the above-described manufacturing method, comprises:
the metal current collector; and
the adhesion enhancement layer formed on at least one surface of the metal current collector, and comprising the first binder polymer and the first conductive material at the weight ratio of 0.5:1 to 8:1,
wherein the first binder polymer comprises the polyvinylidenefluoride-based polymer,
the first binder polymer is distributed in island arrays over the surface of the metal current collector, and
the melting point of the polyvinylidenefluoride-based polymer is 50 to 150° C.

The type of the metal current collector, the first binder polymer, the first conductive material and the adhesion enhancement layer that make up the positive electrode current collector coated with the adhesion enhancement layer has been described above, and its detailed description is omitted.

After the positive electrode current collector coated with the adhesion enhancement layer is manufactured by the above-described manufacturing method, the positive electrode active material layer comprising a positive electrode active material, a second conductive material and a second binder polymer is stacked on and attached to the adhesion enhancement layer to manufacture a positive electrode for a lithium secondary battery.

The positive electrode active material layer comprises a positive electrode active material, the second conductive material and the second binder polymer, in the same way as the common positive electrode active material layers for lithium secondary batteries.

The positive electrode active material may include the common positive electrode active materials used in lithium secondary batteries, for example, lithium transition metal oxide. In particular, the positive electrode active material may include positive electrode active materials represented by the following Formula 1.

Li₁₊ₐFe₁₋ₓMₓ(PO_{4-b})X_{b} (M is at least one selected from the group consisting of Al, Mg, Ni, Co, Mn, Ti, Ga, Cu, V, Nb, Zr, Ce, In, Zn or Y, and X is at least one selected from the group consisting of F, S or N, −0.5≤a≤+0.5, 0≤x≤0.5, 0≤b≤0.1. <Formula 1>

The positive electrode active material of the above Formula 1 is a lithium iron phosphate-based compound, and has low adhesion strength especially with the aluminum current collector. Accordingly, when the adhesion enhancement layer according to the present disclosure is applied, there is a growing industrial need for the improved adhesion strength with the current collector.

The second binder polymer used to bind the positive electrode active material may typically include binder polymers applied to positive electrode materials, for example, at least one of polyvinylidene fluoride (PVDF), polyvinylidene fluoride-hexafluoropropylene copolymer (PVDF-co-HFP), polyvinylalcohol, polyacrylonitrile, carboxymethylcellulose (CMC), starch, hydroxypropyl cellulose, regenerated cellulose, polyvinylpyrrolidone, polytetrafluoroethylene, polyethylene, polypropylene, ethylene-propylene-diene polymer (EPDM), sulfonated-EPDM, styrene butadiene rubber (SBR), fluoro rubber, or a variety of copolymers thereof. More preferably, the second binder polymer may include polyvinylidenefluoride-based polymer, and the interaction of the adhesion enhancement layer with the polyvinylidenefluoride-based polymer increases the interlayer adhesion strength improvement effect. In this view, more preferably, the second binder polymer may include at least one selected from the group consisting of polyvinylidenefluoride, poly(vinylidenefluoride-hexafluoropropylene) and poly(vinylidenefluoride-chlorotrifluoroethylene). The binder may be included in an amount of 1 to 30 weight % based on the total weight of the positive electrode active material layer.

For the second conductive material used in the positive electrode active material layer, the first conductive material of the adhesion enhancement layer may be independently used. The second conductive material may be typically included in an amount of 1 to 30 weight % based on the total weight of the positive electrode active material layer.

The method for stacking the positive electrode active material layer and attaching it to the adhesion enhancement layer may include the methods commonly used in the corresponding technical field.

For example, a positive electrode active material layer forming composition comprising the positive electrode active material, the second conductive material and the second binder polymer on the adhesion enhancement layer may be coated, dried and pressed.

In this instance, a solvent used in the positive electrode active material layer forming composition may include solvents commonly used in the corresponding technical field, for example, at least one of dimethyl sulfoxide (DMSO), isopropyl alcohol, N-methylpyrrolidone (NMP), acetone or water. The solvent may be used in such an amount to have sufficient viscosity for dissolving the binder polymer, dispersing the conductive material and the positive electrode active material, and subsequently, achieving good thickness uniformity when coating for manufacturing the positive electrode in view of the coating thickness of the coating solution and the production yield.

The polyvinylidenefluoride-based polymer included in the adhesion enhancement layer has flowability when subjected to heat and pressure. For example, when subjected to heat and pressure at higher temperature than the glass transition temperature of the polyvinylidenefluoride-based polymer in the temperature range of the melting point (Tm) of the polymer-60° C. to the melting point (Tm) of the binder polymer+60° C., more specifically the temperature range of the melting point (Tm) of the binder polymer−50° C. to the melting point (Tm) of the binder polymer+50° C., and more specifically in the temperature range of the melting point (Tm) of the binder polymer−40° C. to the melting point (Tm) of the binder polymer+30° C., the binder polymer of the adhesion enhancement layer becomes flowable by the heat and attaches to the surface layer of the positive electrode active material layer in contact with the adhesion enhancement layer.

In the positive electrode for a lithium secondary battery according to an aspect, manufactured by the above-described manufacturing method, the thickness of the positive electrode active material layer (the thickness of the positive electrode active material layer formed on one surface of the adhesion enhancement layer, not two surfaces of the adhesion enhancement layer after pressing) may be 40 to 200 μm, but is not limited thereto.

The adhesion strength of the positive electrode active material layer is preferably 30 gf/2 cm or more, and more preferably 40 gf/2 cm or more. Additionally, the interfacial resistance of the positive electrode active material layer is preferably 3 Ωcm² or less, and more preferably 2 Ωcm² or less.

The positive electrode for a lithium secondary battery according to an aspect, manufactured by the above-described manufacturing method comprises:
the positive electrode current collector coated with the adhesion enhancement layer; and
the positive electrode active material layer attached onto the adhesion enhancement layer, and comprising the positive electrode active material, the second conductive material and the second binder polymer.

The metal current collector, the binder polymers, the conductive materials and the positive electrode active material that make up the positive electrode for a lithium secondary battery have been hereinabove described, and a detailed description is omitted.

According to another embodiment of the present disclosure, there is provided a lithium secondary battery comprising the positive electrode for a lithium secondary battery.

Specifically, the lithium secondary battery comprises the positive electrode, a negative electrode opposite the positive electrode, a separator between the positive electrode and the negative electrode and an electrolyte, and the positive electrode is the same as described above. Additionally, optionally, the lithium secondary battery may further comprise a battery case accommodating an electrode assembly comprising the positive electrode, the negative electrode and the separator, and a sealing member to seal up the battery case.

In the lithium secondary battery, the negative electrode comprises a negative electrode current collector and a negative electrode active material layer on the negative electrode current collector.

The negative electrode current collector is not limited to a particular type and may include those having high conductivity without causing any chemical change to the battery, for example, copper, stainless steel, aluminum, nickel, titanium, sintered carbon, copper or stainless steel treated with carbon, nickel, titanium or silver on the surface and an aluminum-cadmium alloy, but is not limited thereto. Additionally, the negative electrode current collector may be typically 3 to 500 μm in thickness, and in the same way as the positive electrode current collector, the negative electrode current collector may have microtexture on the surface to improve the bonding strength of the negative electrode active material. For example, the negative electrode current collector may come in various forms, for example, films, sheets, foils, nets, porous bodies, foams and non-woven fabrics.

In addition to the negative electrode active material, the negative electrode active material layer optionally comprises a binder and a conductive material. For example, the negative electrode active material layer may be formed by applying a negative electrode forming composition comprising the negative electrode active material, and optionally the binder and the conductive material on the negative electrode current collector and drying, or by casting the negative electrode forming composition on a support, peeling off a film from the support and laminating the film on the negative electrode current collector.

The negative electrode active material may include compounds capable of reversibly intercalating and deintercalating lithium. Specific examples may include at least one of a carbonaceous material, for example, artificial graphite, natural graphite, graphitizing carbon fibers, amorphous carbon; a metallic compound that can form an alloy with lithium, for example, Si, Al, Sn, Pb, Zn, Bi, In, Mg, Ga, Cd, a Si alloy, a Sn alloy or an Al alloy; metal oxide capable of doping and undoping lithium such as SiOβ (0<β<2), SnO₂, vanadium oxide, lithium vanadium oxide; or a complex comprising the metallic compound and the carbonaceous material such as a Si—C complex or a Sn—C complex. Additionally, a metal lithium thin film may be used for the negative electrode active material. Additionally, the carbon material may include low crystalline carbon and high crystalline carbon. The low crystalline carbon typically includes soft carbon and hard carbon, and the high crystalline carbon typically includes high temperature sintered carbon, for example, amorphous, platy, flaky, spherical or fibrous natural graphite or artificial graphite, Kish graphite, pyrolytic carbon, mesophase pitch based carbon fibers, meso-carbon microbeads, mesophase pitches and petroleum or coal tar pitch derived cokes.

Additionally, the binder and the conductive material may be the same as those of the positive electrode described above.

On the other hand, in the lithium secondary battery, the separator separates the negative electrode from the positive electrode and provides a passage for movement of lithium ions, and may include, without limitation, any separator commonly used in lithium secondary batteries, and in particular, preferably, those having low resistance to the electrolyte ion movement and good electrolyte solution wettability. Specifically, the separator may include, for example, a porous polymer film made of a polyolefin-based polymer such as an ethylene homopolymer, a propylene homopolymer, an ethylene/butene copolymer, an ethylene/hexene copolymer and an ethylene/methacrylate copolymer or a stack structure of two or more porous polymer films. Additionally, the separator may include common porous non-woven fabrics, for example, non-woven fabrics made of high melting point glass fibers and polyethylene terephthalate fibers. Additionally, to ensure the heat resistance or mechanical strength, the coated separator comprising ceramics or polymer materials may be used, and may be selectively used with a mono- or multi-layer structure.

Additionally, the electrolyte used in the present disclosure may include an organic liquid electrolyte, an inorganic liquid electrolyte, a solid polymer electrolyte, a gel polymer electrolyte, a solid inorganic electrolyte and a molten inorganic electrolyte, available in the manufacture of lithium secondary batteries, but is not limited thereto.

Specifically, the electrolyte may be an electrolyte solution comprising an organic solvent and a lithium salt.

The organic solvent may include, without limitation, any type of organic solvent that acts as a medium for the movement of ions involved in the electrochemical reaction of the battery. Specifically, the organic solvent may include an ester-based solvent, for example, methyl acetate, ethyl acetate, γ-butyrolactone, ε-caprolactone; an ether-based solvent, for example, dibutyl ether or tetrahydrofuran; a ketone-based solvent, for example, cyclohexanone; an aromatic hydrocarbon-based solvent, for example, benzene, fluorobenzene; a carbonate-based solvent, for example, dimethylcarbonate (DMC), diethylcarbonate (DEC), ethylmethylcarbonate (EMC), ethylene carbonate (EC), propylene carbonate (PC); an alcohol-based solvent, for example, ethylalcohol, isopropyl alcohol; nitriles of R—CN (R is a C2 to C20 straight-chain, branched-chain or cyclic hydrocarbon, and may comprise an exocyclic double bond or ether bond); amides, for example, dimethylformamide; dioxolanes, for example, 1,3-dioxolane; or sulfolanes. Among them, the carbonate-based solvent is desirable, and more preferably, the cyclic carbonate (for example, ethylene carbonate or propylene carbonate) having high ionic conductivity and high dielectric constant which contributes to the improved charge/discharge performance of the battery may be mixed with the linear carbonate-based compound (for example, ethylmethyl carbonate, dimethyl carbonate or diethyl carbonate) of low viscosity. In this case, the cyclic carbonate and the chain carbonate may be mixed at a volume ratio of about 1:1 to about 1:9 to improve the performance of the electrolyte solution.

The lithium salt may include, without limitation, any compound that can provide lithium ions used in lithium secondary batteries. Specifically, the lithium salt may include LiPF₆, LiClO₄, LiAsF₆, LIBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI or LiB(C₂O₄)₂. The concentration of the lithium salt may range from 0.1 to 2.0M. When the concentration of the lithium salt is included in the above-described range, the electrolyte has the optimal conductivity and viscosity, resulting in good performance of the electrolyte and effective movement of lithium ions.

In addition to the above-described constituent substances of the electrolyte, the electrolyte may further comprise, for example, at least one type of additive of a haloalkylene carbonate-based compound such as difluoro ethylene carbonate, pyridine, triethylphosphite, triethanolamine, cyclic ether, ethylene diamine, n-glyme, hexaphosphoric triamide, nitrobenzene derivatives, sulfur, a quinone imine dye, N-substituted oxazolidinone, N,N-substituted imidazolidine, ethylene glycol dialkyl ether, an ammonium salt, pyrrole, 2-methoxy ethanol or aluminum trichloride to improve the life characteristics of the battery, prevent the capacity fading of the battery and improve the discharge capacity of the battery. In this instance, the additive may be included in an amount of 0.1 to 5 weight % based on the total weight of the electrolyte.

The lithium secondary battery is useful in the field of mobile devices including mobile phones, laptop computers and digital cameras, and electric vehicles including hybrid electric vehicles (HEVs).

Accordingly, according to another embodiment of the present disclosure, there are provided a battery module comprising the lithium secondary battery as a unit cell and a battery pack comprising the same.

The battery module or the battery pack may be used as a power source of at least one medium- and large-scale device of power tools; electric vehicles including electric vehicles (EVs), hybrid electric vehicles, and plug-in hybrid electric vehicles (PHEVs); or energy storage systems.

Hereinafter, the embodiment of the present disclosure will be described in sufficiently detail for those having ordinary skill in the technical field pertaining to the present disclosure to easily practice the present disclosure. However, the present disclosure may be embodied in many different forms and is not limited to the disclosed embodiment.

### Example 1

Polymer A (Solvay, vinylidenefluoride-hexafluoropropylene copolymer, VDF:HFP=3:1 (weight ratio), the average particle size: 250 nm, the melting point: 100° C., Mw=1,080,000)] as a first binder polymer and denka carbon black (BET=60 m²/g, DBP=200 ml/100 g) were dispersed in water at a weight ratio of 2:1, and Daicel 2200 as a thickening agent was fed at ⅕ of the weight of the binder polymer to prepare an aqueous slurry comprising 10% solids. Subsequently, the aqueous slurry was coated on two surfaces of a 20 μm thick aluminum foil using a Micro gravure coater and dried at 120° C. for 3 min to form an adhesion enhancement layer on the aluminum foil. A positive electrode active material slurry prepared by mixing LiFe(PO₄), polyvinylidenefluoride (Mw=630,000) as a second binder polymer and denka carbon black (BET=60 m²/g, DBP=200 ml/100 g) at 96:2:2 were coated on the adhesion enhancement layer, dried at 140° C. for 10 min and pressed to manufacture a positive electrode.

Lithium metal was used for a negative electrode, and the negative electrode and the positive electrode were stacked with a separator (Celgard) interposed between the negative electrode and the positive electrode to manufacture an electrode assembly. The electrode assembly was punched into a coin shape, and an electrolyte solution in which 1M LiPF6 was dissolved in a mixed solvent (PC:EMC:EC=3:4:3) of propylene carbonate (PC), ethylmethyl carbonate (EMC) and ethylene carbonate (EC) was injected to manufacture a test lithium secondary battery.

### Example 2

A lithium secondary battery was manufactured in the same way as example 1 except that changes were made as shown in the following Table 1.

### Example 3

A lithium secondary battery was manufactured in the same way as example 1 except that changes were made as shown in the following Table 1.

### Example 4

A lithium secondary battery was manufactured in the same way as example 1 except that for the first binder polymer, polymer B (Solvay, vinylidenefluoride-hexafluoropropylene copolymer, VDF:HFP-97:3 (weight ratio), average particle size: 250 nm, melting point: 140° C., Mw=800,000)] was used, and changes were made as shown in the following Table 1.

### Example 5

A lithium secondary battery was manufactured in the same way as example 1 except that changes were made as shown in the following Table 1. The weight ratio of polymer A:denka carbon black:Mw-CNT in example 5 was 2:1:0.1.

### Comparative Example 1

A lithium secondary battery was manufactured in the same way as example 1 except that changes were made as shown in the following Table 1.

### Comparative Example 2

A lithium secondary battery was manufactured in the same way as example 1 except that for the first binder polymer, polymer C (Solvay, polyvinylidenefluoride, average particle size: 250 nm, melting point: 168° C., Mw=600,000)] was used, and changes were made as shown in the following Table 1.

### Comparative Example 3

A lithium secondary battery was manufactured in the same way as example 1 except that the adhesion enhancement layer was formed as below.

Polymer D (Solvay, polyvinylidenefluoride, melting point: 168° C., Mw=630,000] as the first binder polymer and denka carbon black (product name: Li-250) were added at a weight ratio of 2:1 to prepare a 10% organic slurry polymer in which the denka carbon black was dispersed and the polymer D was dissolved in NMP. Subsequently, the organic slurry was coated on two surfaces of a 20 μm thick aluminum foil and dried at 120° C. for 3 min to form an adhesion enhancement layer on the aluminum foil.

### Comparative Example 4

A lithium secondary battery was manufactured in the same way as comparative example 3 except that polymer E (Solvay, polyvinylidenefluoride, melting point: 170° C., Mw=1,000,000) as the first binder polymer and denka carbon black (BET=60 m²/g, DBP=200 ml/100 g) were added at a weight ratio of 2:1 to prepare a 10% organic slurry in which the denka carbon black was dispersed and the polymer E was dissolved in NMP.

### Example 6

Polymer A (Solvay, vinylidenefluoride-hexafluoropropylene copolymer, VDF:HFP=3:1 (weight ratio), average particle size: 250 nm, melting point: 100° C., Mw=1,080,000)] as a first binder polymer and denka carbon black (product name: Li-250) having the average particle size of 37 nm as a first conductive material were dispersed in water at a weight ratio of 2:1, Daicel 2200 as a thickening agent was fed at ⅕ of the weight of the binder polymer to prepare an aqueous slurry comprising 10% solids. Subsequently, the aqueous slurry was coated on two surfaces of a 20 μm thick aluminum foil using a Micro gravure coater and dried at 120° C. for 3 min to form an adhesion enhancement layer on the aluminum foil. A positive electrode active material slurry prepared by mixing LiFe(PO₄), polyvinylidenefluoride (Mw=630,000) as the second binder polymer and denka carbon black (product name: Li-250) as the second conductive material at 96:2:2 were coated on the adhesion enhancement layer, dried at 140° C. for 10 minutes and pressed to manufacture a positive electrode.

Lithium metal was used for a negative electrode, and the negative electrode and the positive electrode were stacked with a separator (Celgard) interposed between the negative electrode and the positive electrode to manufacture an electrode assembly. The electrode assembly was punched into a coin shape, and an electrolyte solution in which 1M LiPF₆ was dissolved in a mixed solvent (PC:EMC:EC=3:4:3) of propylene carbonate (PC), ethylmethyl carbonate (EMC) and ethylene carbonate (EC) was injected to manufacture a test lithium secondary battery.

### Example 7

A lithium secondary battery was manufactured in the same way as example 6 except that denka carbon black (product name: Li-435) having the average particle size of 23 nm was used for the first conductive material, and the ratio of the polymer A and the conductive material was changed to 1:1.

### Example 8

A lithium secondary battery was manufactured in the same way as example 6 except that changes were made as shown in the following Table 2.

### Example 9

A lithium secondary battery was manufactured in the same way as example 6 except that polymer B (Solvay, vinylidenefluoride-hexafluoropropylene copolymer, VDF:HFP-97:3 (weight ratio), average particle size: 250 nm, melting point: 140° C., Mw=800,000)] was used for the first binder polymer and changes were made as shown in the following Table 2.

### Example 10

A lithium secondary battery was manufactured in the same way as example 6 except that LiNi_{0.50}Co_{0.20}Mn_{0.30}O₂ was used instead LiFe(PO₄), polyvinylidenefluoride (Mw=630,000) was used for the second binder polymer, Super-P was used for the second conductive material and their weight ratio was 97.5:1.5:1.

### Comparative Examples 5 and 6

A lithium secondary battery was manufactured in the same way as example 6 except that changes were made as shown in the following Table 2.

### Comparative Example 7

A lithium secondary battery was manufactured in the same way as example 5 except that LiNi_{0.50}Co_{0.20}Mn_{0.30}O₂ was used instead of LiFe(PO₄), polyvinylidenefluoride (Mw=630,000) was used for the second binder polymer, Super-P was used for the second conductive material and their weight ratio was 97.5:1.5:1.

### Comparative Example 8

A lithium secondary battery was manufactured in the same way as example 6 except that the adhesion enhancement layer was formed as below.

Polymer C (Solvay, polyvinylidenefluoride, melting point: 168° C., Mw=880,000] as a first binder polymer and denka carbon black (product name: Li-250) were added at a weight ratio of 2:1 to prepare an 10% organic slurry in which the denka carbon black was dispersed and the polymer C was dissolved in NMP. Subsequently, the organic slurry was coated on two surfaces of a 20 μm thick aluminum foil and dried at 120° C. for 3 min to form an adhesion enhancement layer on the aluminum foil.

### <Melting Point Measurement of Binder Polymer>

The melting point of the binder polymer was measured using differential scanning calorimetry (DSC).

5 to 10 mg of specimen was fed using TA DSC2500, and thermal scanning was performed with the increasing temperature at the heating rate of 10° C./min from 50 to 250° C. under a nitrogen atmosphere, the decreasing temperature at the cooling rate of 10° C./min, and the increasing temperature at the heating rate of 10° C./min from 50 to 250° C.

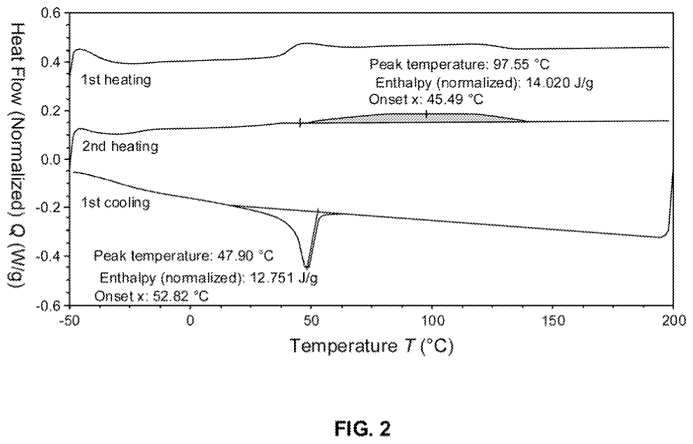

FIG. 2 is a DSC chart of polymer A of example 1. Referring to FIG. 2, a melting point may be obtained by endothermic peaks during 2^{nd} heating, and the melting point is found to be the temperature at the peak apex.

### <Weight Average Molecular Weight Measurement of Polymer>

0.04 g of polymer was taken and dissolved in 10 g of tetrahydrofuran to prepare a sample specimen, and a reference specimen (polystyrene) and the sample specimen were filtered through a filter having the pore size of 0.45 μm, and injected into a GPC injector. The number average molecular weight, the weight average molecular weight and the polydispersity of the acrylic polymer were measured by comparing the elution time of the sample specimen with the calibration curve of the reference specimen. The measurements were made at the flow rate of 1.00 mL/min and the column temperature of 35.0° C. using GPC (Infinity II 1260, Agilient).

### <Average Particle Size Measurement of Polymer Particles>

The polymer particles were scanned by SEM and the average particle size was measured by averaging the lengths of long axes.

### <Average Particle Size Measurement of Conductive Material>

The average particle size D50 of the conductive material was measured using laser diffraction. The conductive material was dispersed in a dispersion medium and the average particle size D50 at 50% of the particle size distribution was calculated using a laser diffraction particle size measurement equipment (Microtac MT 3000).

### <Adhesion Strength Evaluation>

The positive electrodes manufactured according to the examples and comparative examples were punched into a size of 2 cm (width)×10 cm (length) or more using a punching machine. Glass was used for a base plate (2.5 cm (width)×7.5 cm (length)×1T (thickness)), a double-sided tape was attached to the glass, and the punched electrode was attached in parallel. The electrode attached to the tape was 6 cm, and the adhesion strength of the electrode was measured while maintaining 90° with the base plate using a texture analyzer (LLOYD).

### <WET Adhesion Strength Evaluation>

The WET adhesion strength evaluation was performed by storing the electrode coated foil through a vacuum drying oven at 130° C. for 24 hr to remove moisture, receiving the electrode in an aluminum pouch together with the electrolyte solution, sealing up the aluminum pouch, storing in the 70° C. oven for 2 weeks and measuring the adhesion strength. In this instance, to remove the remaining electrolyte solution, the electrode was washed using a DMC washing solution and completely dried, and measurements were made. As the adhesion enhancement layer was less resistant to dissolution than before the evaluation of the resistance to the electrolyte solution, the adhesion strength of the adhesion enhancement layer to the electrolyte solution was lower when applied to lithium secondary batteries.

### <Interfacial Resistance Evaluation>

The positive electrodes manufactured according to the examples and comparative examples were punched into a size of 5 cm (horizontal)×5 cm (vertical) using a punching machine. Each of the thickness of the punched electrode, the thickness of the aluminum foil and the specific resistance value (2.82E-06) of the current collector was input using Mp tester (HIOKI), and the punched electrode was placed below a tip at which a probe was embedded and measured by lowering the bar.

TABLE 1

| | | | | | | | Compar- | Compar- | Compar- | Compar- |
|---|---|---|---|---|---|---|---|---|---|---|
| | | | | | | | ative | ative | ative | ative |
| | | Exam- | Exam- | Exam- | Exam- | Exam- | exam- | exam- | exam- | exam- |
| | | ple 1 | ple 2 | ple 3 | ple 4 | ple 5 | ple 1 | ple 2 | ple 3 | ple 4 |
| Adhesion | First binder | Polymer | Polymer | Polymer | Polymer | Polymer | Polymer | Polymer | Polymer | Polymer |
| enhancement | | A | A | A | B | A | A | C | D | E |
| layer | First | 2:1 | 2:1 | 5:1 | 2:1 | 2:1:0.1(Mw- | 10:0 | 2:1 | 2:1 | 2:1 |
| | binder:Conductive | | | | | CNT) | | | | |
| | material | | | | | | | | | |
| | (weight ratio) | | | | | | | | | |
| | Thickness | 200 | 500 | 100 | 200 | 200 | 200 | 200 | 200 | 300 |
| | (nm, one side/ | | | | | | | | | |
| | contact type) | | | | | | | | | |
| | Drying temperature | 120 | 120 | 120 | 150 | 120 | 120 | 170 | 120 | 120 |
| | (° C.) | | | | | | | | | |
| | Coating phase | Island | Island | Island | Island | Island | Island | Island | Overall | Overall |
| | of binder | | | | | | | | distri- | distri- |
| | | | | | | | | | bution | bution |
| Positive | Thickness | 106 | 100 | 103 | 108 | 106 | 106 | 100 | 106 | 110 |
| electrode | (um, before | | | | | | | | | |
| active | pressing, one side) | | | | | | | | | |
| material | Thickness | 90 | 90 | 90 | 91 | 90 | 90 | 89 | 92 | 88 |
| layer | (um, after | | | | | | | | | |
| | pressing, one side) | | | | | | | | | |
| Results | Adhesion | 62 | 81.5 | 102 | 52 | 62 | 112 | 27 | 12 | 50 |
| | (gf/2cm) | | | | | | | | | |
| | Interfacial | 0.25 | 0.1 | 0.98 | 0.28 | 0.2 | 8 | 0.8 | 2.5 | 3.1 |
| | resistance | | | | | | | | | |
| | (Ω/cm²) | | | | | | | | | |
| Durability | WET | 81 | 94 | 110 | 63 | 78 | 120 | 26 | 5 | 29 |
| evaluation | adhesion | | | | | | | | (detached) | |
| (Resistance to | strength | | | | | | | | | |
| electrolyte | | | | | | | | | | |
| solution) | | | | | | | | | | |

TABLE 2

| | | | | | | | Compar- | Compar- | Compar- | Compar- |
|---|---|---|---|---|---|---|---|---|---|---|
| | | | | | | | ative | ative | ative | ative |
| | | Exam- | Exam- | Exam- | Exam- | Exam- | exam- | exam- | exam- | exam- |
| | | ple 6 | ple 7 | ple 8 | ple 9 | ple 10 | ple 5 | ple 6 | ple 7 | ple 8 |
| Adhesion | First binder | Polymer | Polymer | Polymer | Polymer | Polymer | Polymer | Polymer | Polymer | Polymer |
| enhancement | | A | A | A | B | A | A | A | A | C |
| layer | First | Li-250 | Li-435 | Li-250 | Li-250 | Li-250 | Li-250 | Li-250 | Li-250 | Li-250 |
| | conductive | (average | (average | (average | (average | (average | (average | (average | (average | (average |
| | material | particle | particle | particle | particle | particle | particle | particle | particle | particle |
| | | size: | size: | size: | size: | size: | size: | size: | size: | size: |
| | | 37 nm) | 23 nm) | 37 nm) | 37 nm) | 37 nm) | 37 nm) | 37 nm) | 37 nm) | 37 nm) |
| | First | 2:1 | 1:1 | 5:1 | 2:1 | 2:1 | 10:1 | 0.3:1 | 10:1 | 2:1 |
| | binder:Conductive | | | | | | | | | |
| | material | | | | | | | | | |
| | (weight ratio) | | | | | | | | | |
| | Thickness | 300 | 300 | 200 | 200 | 200 | 200 | 400 | 200 | 300 |
| | (nm, one side/ | | | | | | | | | |
| | contact type) | | | | | | | | | |
| | Drying temperature | 120 | 120 | 120 | 150 | 120 | 120 | 120 | 120 | 120 |
| | (° C.) | | | | | | | | | |
| | Coating phase | Island | Island | Island | Island | Island | Island | Island | Island | Overall |
| | of binder | | | | | | | | | distri- |
| | | | | | | | | | | bution |
| Positive | Type of active | LFP | LFP | LFP | LFP | NCM | LFP | LFP | NCM | LFP |
| electrode | material | | | | | | | | | |
| active | Thickness | 110 | 112 | 115 | 117 | 117 | 111 | 115 | 112 | 110 |
| material | (um, before | | | | | | | | | |
| layer | pressing, one side) | | | | | | | | | |
| | Thickness | 92 | 90 | 90 | 92 | 81 | 89 | 92 | 78 | 95 |
| | (um, after | | | | | | | | | |
| | pressing, one side) | | | | | | | | | |
| Results | Adhesion | 58 | 52 | 72 | 47 | 71 | 92 | 12 | 117 | 62 |
| | (gf/2cm) | | | | | | | (detached) | | |
| | interfacial | 0.4 | 0.1 | 1.1 | 0.5 | 0.1 | 4.2 | 0.05 | 3.2 | 3.6 |
| | resistance | | | | | | | | | |
| | (Ω/cm²) | | | | | | | | | |
| Durability | WET | 72 | 66 | 98 | 62 | 99 | 111 | 10 | 120 | 88 |
| evaluation | Adhesion | | | | | | | | | |
| (Resistance to | (gf/2cm) | | | | | | | | | |
| electrolyte | | | | | | | | | | |
| solution) | | | | | | | | | | |

Referring to the results of Tables 1 and 2, it can be seen that the positive electrodes of examples 1 to 10 having the adhesion enhancement layer containing the binder polymer and the conductive material according to the present disclosure had the improved adhesion strength and low interfacial resistance when using the specific binder component.

In contrast, it can be seen that comparative example 1 containing no conductive material had high interfacial resistance, and comparative example 2 containing no binder polymer having the specific melting point of the present disclosure had lower adhesion strength than the positive electrodes of the examples. Additionally, it can be seen that comparative examples 3, 4 and 8 using the organic slurry in which the binder polymer is dissolved in the solvent had high interfacial resistance.

Additionally, it can be seen that comparative examples 5 and 7 having very low weight ratio of the first conductive material to the first binder polymer had very high interfacial resistance, and comparative example 6 having very high weight ratio of the first conductive material to the first binder polymer had very low adhesion strength.

1. A method for manufacturing a positive electrode current collector coated with an adhesion enhancement layer, comprising:
preparing an aqueous slurry comprising:
a first binder polymer comprising polyvinylidene fluoride-based polymer particles having a melting point of 50 to 150° C.; and
a first conductive material,
wherein a weight ratio of the first binder polymer to the first conductive material is from 0.5:1 to 8:1; and
coating the aqueous slurry on at least one surface of a metal current collector and drying by thermal treatment at a higher temperature than the melting point of the polyvinylidene fluoride-based polymer particles to form the adhesion enhancement layer.

2. The method for manufacturing the positive electrode current collector coated with the adhesion enhancement layer according to claim 1, wherein the melting point of the polyvinylidene fluoride-based polymer particles is from 70 to 150° C.

3. The method for manufacturing the positive electrode current collector coated with the adhesion enhancement layer according to claim 1, wherein the polyvinylidene fluoride-based polymer particles are vinylidene fluoride-hexafluoropropylene copolymer particles.

4. The method for manufacturing the positive electrode current collector coated with the adhesion enhancement layer according to claim 1, wherein a weight average molecular weight of polyvinylidene fluoride-based polymer of the polyvinylidene fluoride-based polymer particles is from 700,000 to 1,300,000.

5. The method for manufacturing the positive electrode current collector coated with the adhesion enhancement layer according to claim 1, wherein an average particle size of the polyvinylidene fluoride-based polymer particles is from 10 nm to 3 μm.

6. The method for manufacturing the positive electrode current collector coated with the adhesion enhancement layer according to claim 1, wherein an average particle size of the polyvinylidene fluoride-based polymer particles is from 100 nm to 1,000 nm, and an average particle size of the first conductive material is from 10 nm to 1,000 nm.

7. The method for manufacturing the positive electrode current collector coated with the adhesion enhancement layer according to claim 6, wherein the average particle size of the polyvinylidene fluoride-based polymer particles is from 3 to 20 times larger than the average particle size of the first conductive material.

8. The method for manufacturing the positive electrode current collector coated with the adhesion enhancement layer according to claim 1, wherein the drying is performed at a temperature that is from 10° C. to 80° C. higher than the melting point of the polyvinylidene fluoride-based polymer particles.

9. A positive electrode current collector coated with an adhesion enhancement layer, comprising:
a metal current collector; and
the adhesion enhancement layer on at least one surface of the metal current collector, the adhesion enhancement layer comprising a first binder polymer and a first conductive material,
wherein a weight ratio of the first binder polymer to the first conductive material is from 0.5:1 to 8:1,
wherein the first binder polymer comprises a polyvinylidene fluoride-based polymer,
wherein the first binder polymer is distributed in an island array over the at least one surface of the metal current collector, and
wherein a melting point of the polyvinylidene fluoride-based polymer is from 50° C. to 150° C.

10. (canceled)

11. The positive electrode current collector coated with the adhesion enhancement layer according to claim 9, wherein the polyvinylidene fluoride-based polymer is a vinylidene fluoride-hexafluoropropylene copolymer.

12. The positive electrode current collector coated with the adhesion enhancement layer according to claim 9, wherein a weight average molecular weight of the polyvinylidene fluoride-based polymer is from 700,000 to 1,300,000.

13. A method for manufacturing a positive electrode for a lithium secondary battery, comprising:
manufacturing the positive electrode current collector coated with the adhesion enhancement layer according to claim 1; and
applying a positive electrode active material layer comprising a positive electrode active material, a second conductive material and a second binder polymer on the adhesion enhancement layer and attaching the positive electrode active material layer to the adhesion enhancement layer.

14. The method for manufacturing the positive electrode for the lithium secondary battery according to claim 13, wherein the metal current collector is aluminum, and the positive electrode active material is represented by the following Formula 1:
Li₁₊ₐFe₁₋ₓMₓ(PO_{4-b})X_{b} where M is at least one of Al, Mg, Ni, Co, Mn, Ti, Ga, Cu, V, Nb, Zr, Ce, In, Zn or Y, and X is at least one of F, S or N, −0.5≤a≤+0.5, 0≤x≤0.5, 0≤b≤0.1. <Formula 1>

15. The method for manufacturing the positive electrode for the lithium secondary battery according to claim 13, wherein the second binder polymer is at least one of polyvinylidene fluoride, poly(vinylidene fluoride-hexafluoropropylene) or poly(vinylidene fluoride-chlorotrifluoroethylene).

16. The method for manufacturing the positive electrode for the lithium secondary battery according to claim 13, wherein the adhesion enhancement layer is from 50 to 5,000 nm in thickness on the at least one surface of the metal current collector, and the positive electrode active material layer is from 40 to 200 μm in thickness on a surface of the adhesion enhancement layer.

17. A positive electrode for a lithium secondary battery, comprising:
the positive electrode current collector coated with the adhesion enhancement layer according to claim 9; and
a positive electrode active material layer attached onto the adhesion enhancement layer, the positive electrode active material layer comprising a positive electrode active material, a second conductive material and a second binder polymer.

18. The positive electrode for a lithium secondary battery according to claim 17, wherein the metal current collector comprises aluminum, and the positive electrode active material is represented by the following Formula 1:
Li₁₊ₐFe₁₋ₓMₓ(PO_{4-b})X_{b} where M is at least one of Al, Mg, Ni, Co, Mn, Ti, Ga, Cu, V, Nb, Zr, Ce, In, Zn or Y, and X is at least one of F, S or N, −0.5≤a≤+0.5, 0≤x≤0.5, 0≤b≤0.1. <Formula 1>

19. The positive electrode for a lithium secondary battery according to claim 17, wherein the second binder polymer is at least one of polyvinylidene fluoride, poly(vinylidene fluoride-hexafluoropropylene) or poly(vinylidene fluoride-chlorotrifluoroethylene).

20. The positive electrode for a lithium secondary battery according to claim 17, wherein the adhesion enhancement layer is from 50 to 5,000 nm in thickness on the at least one surface of the metal current collector, and the positive electrode active material layer is from 40 to 200 μm in thickness on a surface of the adhesion enhancement layer.

21. A lithium secondary battery comprising the positive electrode according to claim 17, a negative electrode opposite the positive electrode, a separator between the positive electrode and the negative electrode, and an electrolyte.
